(19) United States
(12) Patent Application Publication
(10) Pub. No.: US 2025/0240842 A1
(43) Pub. Date: Jul. 24, 2025

(54) AVOIDING VENDOR SPECIFIC PPDU VIA ASSOCIATION IDENTIFIER VETOING

(71) Applicant: Cisco Technology, Inc., San Jose, CA (US)

(72) Inventors: Brian Donald Hart, Sunnyvale, CA (US); Binita Gupta, San Diego, CA (US); Malcolm Muir Smith, Richardson, TX (US)

(21) Appl. No.: 19/035,193

(22) Filed: Jan. 23, 2025

Related U.S. Application Data
(60) Provisional application No. 63/624,007, filed on Jan. 23, 2024.
(60) Provisional application No. 63/669,177, filed on Jul. 9, 2024.

(51) Int. Cl. H04W 76/15; H04W 24/02; H04W 88/08

(52) U.S. Cl. CPC H04W 76/15; H04W 24/02; H04W 88/08

(57) ABSTRACT

In one aspect, a method includes receiving, at a first access point and from a non-access point device, a request, wherein the request includes an element to signal to the first access point to exclude each of at least one association identifier indicated in the element when assigning an association identifier to the non-access point device; assigning the association identifier to the non-access point device, wherein the association identifier is different from each of the at least one association identifier indicated in the element; and completing an association process with the non-access point device using the association identifier.

### CROSS-REFERENCE TO RELATED APPLICATIONS

This application claims priority to and the benefit of U.S. Prov. App. No. 63/624,007, filed on Jan. 23, 2024, and U.S. Prov. App. 63/669,177, filed on Jul. 9, 2024, contents of which are expressly incorporated herein by reference in the entirety.

### TECHNICAL FIELD

The present technology pertains to wireless communication network, and more specifically, to enable signaling of vendor specific features between an access point and a corresponding device having multiple STAs.

### BACKGROUND

Wi-Fi technology has undergone continuous evolution and innovation since its inception, resulting in significant advancements with each new generation. Following Wi-Fi 5 (802.11ac) there has been Wi-Fi 6 (802.11ax), Wi-Fi 7 (802.11be), and soon there will be Wi-Fi 8 and Wi-Fi 9 (802.11ce), each new Wi-Fi generation brings notable improvements in speed, capacity, efficiency, and overall performance.

Wi-Fi 5 introduced substantial upgrades over its predecessor, Wi-Fi 4 (802.11n). It introduced the use of wider channel bandwidths, multi-user Multiple-Input Multiple-Output (MIMO), and beamforming technologies. These advancements significantly increased data transfer rates and improved network capacity, allowing multiple devices to simultaneously connect and communicate more efficiently. Wi-Fi 6 included enhanced orthogonal frequency-division multiple access (OFDMA) and target wake time (TWT) mechanisms and included greater frequency and improved overall spectral efficiency and power management and better performance in crowded areas. Wi-Fi 7 (802.11be) delivers speeds of up to 36 Gbps, utilizing multi-band operation, advanced MIMO techniques, and improved modulation schemes. Wi-Fi 7 also focuses on reducing latency and enhancing security features.

Wi-Fi 8 (802.11bn) aims to further revolutionize wireless connectivity. It is expected to introduce advancements like multi-AP coordination and seamless roaming, paving the way for futuristic applications and seamless connectivity experiences.

As Wi-Fi technology continues to evolve, each new Wi-Fi generation brings improvements that address the growing demands of modern networks, including increased device density, higher data rates, lower latency, and better overall network performance. These advancements play a crucial role in enabling emerging technologies, supporting the proliferation of smart devices, and transforming the way we connect and communicate in an increasingly interconnected world.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a block diagram of an example wireless communication network according to some aspects of the present disclosure.

FIG. 2A illustrates an example of a single floor of building equipped with wireless communication according to some aspects of the present disclosure.

FIG. 2B depicts an illustrative schematic diagram for MLO between an AP MLD with affiliated logical entities and a Non-AP MLD with affiliated logical entities according to some aspects of the present disclosure.

FIG. 3 illustrates an example of a seamless mobility domain according to some aspect of the present disclosure.

FIG. 4 illustrates an example scenario of a non-AP device association with multiple APs according to some aspects of the present disclosure.

FIG. 5 illustrates an example element format to be used for pre-association AID vetoing element and/or post-association AID vetoing according to some example embodiments.

FIG. 6A illustrates a method of ensuring unique AID assignment to non-AP STAs according to one aspect of the present disclosure.

FIG. 6B illustrates a method of ensuring unique AID assignment to non-AP STAs according to one aspect of the present disclosure.

FIG. 7 shows an example of computing system according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

### Abbreviations

Access Point (AP)
Advanced Encryption Standard (AES)
Association and key management (AKM)
Basic service set (BSS)
Extended Service Set (ESS)
Extremely high throughput (EHT)
Fast Transition (FT)
Mobile Device Management (MDM)
Multi-Link Device (MLD)
Multi-link Operation (MLO)
Network Interface Device (NID)
Pairwise Master Key (PMK)
Pairwise Transient Key (PTK)
Robust Security Network Element (RSNE)
Seamless Mobility Domain (SMD)
Service Set Identifier (SSID)
Station (STA)
Wi-Fi Protected Access (WPA)
Wireless Local Area Network (WLAN)
Wireless LAN Controller (WLC)

As used herein, the term “configured” shall be considered to be used interchangeably with configured and configurable, unless the term “configurable” is explicitly used to distinguish from “configured.” The proper understanding of the term will be apparent to persons of ordinary skill in the art in the context in which the term is used.

Aspects of the present disclosure can be implemented in any device, system or network that is capable of transmitting and receiving radio frequency (RF), terahertz, infra-red, visible light, ultra-violet or ultrasonic signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF), terahertz, infra-red, visible light, ultra-violet or ultrasonic signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF), terahertz, infra-red, visible light, ultra-violet or ultrasonic signals suitable for use in one or more of a wireless personal area network (WPAN), a wireless local area network (WLAN), a wireless wide area network (WWAN), or an internet of things (IoT) network.

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum, and power efficiency calls for updates or amendments to the standard to keep up with them. As such, Wi-Fi generally has a new connectivity amendment after every few years with its own characteristic features. In the earlier generations, the focus was primarily higher data rates, but with ever increasing density of devices, area efficiency has become a major concern for Wi-Fi networks. Due to this issue, the recent (802.11ax (Wi-Fi 6) and 802.11be (Wi-Fi 7)) amendments focused more on efficiency though higher data rates were also included. The next expected update to IEEE 802.11 is coined as Wi-Fi 8. Wi-Fi 8 will attempt to further enhance throughput, minimize latency and improve reliability to meet the ever-growing demand for the Internet of Things (IoT), high resolution video streaming, low-latency wireless services, etc.

Multiple Access Point (AP) coordination and transmission in Wi-Fi refers to the management of multiple access points in a wireless network to minimize interference and ensure efficient communication between the STA devices and the network. When multiple access points are deployed in a network—for instance in buildings and office complexes-some operate on the same radio frequency, which can cause interference and degrade the network performance. To mitigate this issue, access points can be configured to coordinate their transmissions and control time, frequency and spatial overlap such that these transmissions successfully reach their intended recipients.

Wi-Fi 7 introduced the concept of multi-link operation (MLO), which gives the devices (Access Points (APs) and Stations (STAs)) the capability to operate on multiple links (such as one link per band) at the same time. MLO introduces a new paradigm to multi-AP coordination which was not part of the earlier coordination approaches. MLO is considered in Wi-Fi-7 to improve the throughput of the network and to address the latency and reliability issues by allowing devices to use multiple links.

A multi-link device (MLD) may have several “affiliated” devices, each affiliated device having a separate PHY interface, and the MLD having a single link to the Logical Link Control (LLC) layer. In IEEE 802.11be, a multi-link device (MLD) is defined as: “A device that is a logical entity and has more than one affiliated station (STA) and has a single medium access control (MAC) service access point (SAP) to logical link control (LLC), which includes one MAC data service” (see: LAN/MAN Standards Committee of the IEEE Computer Society, Amendment 8: Enhancements for extremely high throughput (EHT), IEEE P802.11be™/D0.1, September 2020, section 3.2). Connection(s) with an MLD on the affiliated devices may occur independently or jointly. A preliminary definition and scope of a multi-link element is described in section 9.4.2.247b of aforementioned IEEE 802.11be draft. An idea behind this information element/container is to provide a way for multi-link devices (MLDs) to share the capabilities of themselves (i.e., at the MLD level) and of their different affiliated links with each other and facilitate the discovery and association processes. However, this information element may still be changed, or new mechanisms may be introduced to share the MLO information (e.g., related to backhaul usage).

In multi-link operation (MLO) both STA and APs can possess multiple links that can be simultaneously active. These links may or may not use the same bands/channels.

MLO allows sending PHY protocol data units (PPDUs) on more than one link between a STA and an AP. The links may be carried on different channels, which may be in different frequency bands. Based on the frequency band and/or channel separation and filter performance, there may be restrictions on the way the PPDUs are sent on each of the links.

MLO may include a basic transmission mode, an asynchronous transmission mode, and a synchronous transmission mode.

In a basic transmission mode, there may be multiple primary links, but a device may transmit a PPDU on one link at a time. The link for transmission may be selected as follows. The device (such as an AP or a STA) may count down a random back off (RBO) on both links and select a link that wins the medium for transmission. The other link may be blocked by in-device interference. In basic transmission mode, aggregation gains may not be achieved.

In an asynchronous transmission mode, a device may count down the RBO on both links and perform PPDU transmission independently on each link. The asynchronous transmission mode may be used when the device can support simultaneous transmission and reception with bands that have sufficient frequency separation such as separation between the 2.4 GHz band and the 5 GHz band. The asynchronous transmission mode may provide both latency and aggregation gains.

In a synchronous PPDU transmission mode, the device may count down the RBO on both links. If a first link wins the medium, both links may transmit PPDUs with both PPDUs ending at the same time. This transmission arrangement may minimize in-device interference and may provide both latency and aggregation gains.

Multi-AP coordination and MLO are two features directed to improve the performance of Wi-Fi networks as the Multi-AP coordination is directed toward utilizing (distributed) coordination between different APs to reduce inter-Basic Service Set (BSS) interference for improved spectrum utilization in dense deployments, and the MLO supports high data rates and low latency by leveraging flexible resource utilization offered by the use of multiple links for the same device.

### Overview

The present disclosure is directed to enabling unique identification of PPDUs with different vendor specific features. This may be achieved via a signaling mechanism that ensures Association Identifiers (AIDs) of different STAs remain distinct when communicating with any given AP.

In one aspect, a method includes receiving, at a first access point and from a non-access point device, a request, wherein the request includes an element to signal to the first access point to exclude each of at least one association identifier indicated in the element when assigning an association identifier to the non-access point device; assigning the association identifier to the non-access point device, wherein the association identifier is different from each of the at least one association identifier indicated in the element; and completing an association process with the non-access point device using the association identifier.

In another aspect, the non-access point device includes two or more virtual stations, and the request is received from a first virtual station of the two or more virtual stations.

In another aspect, the at least one association identifier indicated in the element is a corresponding association identifier used by a second virtual station of the two or more virtual stations associated with a second access point.

In another aspect, the first access point supports a first vendor specific physical layer features and the second access point supports a second vendor specific physical layer features, at least one of the first access point or the second access point does not support any vendor specific features, or the first access point supports a first vendor specific physical layer features, the second access point supports a second vendor specific physical layer features, and the non-access point device supports the first vendor specific physical layer features only.

In another aspect, the element includes a plurality of association identifiers, one of which corresponds to an already in-use association identifier used by a different virtual station of the non-access point device to associate with a second access point.

In another aspect, the request is an initial association request when the non-access point device attempts to associate with the first access point for a first time, or the request is a follow up association identifier uniqueness request when the non-access point device attempts to change from a previously assigned association identifier to the association identifier.

In another aspect, the element directly identifies the at least one association identifier, or implicitly identifies the at least one association identifier via a station identifier (STAID) associated with the non-access point device.

In one aspect, an access point includes one or more memories having computer-readable instructions stored therein, and one or more processors. The one or more processors are configured to execute the computer-readable instructions to receive, from a non-access point device, a request, wherein the request includes an element to signal to the access point to exclude each of at least one association identifier indicated by the element when assigning an association identifier to the non-access point device; assign the association identifier to the non-access point device, wherein the association identifier is different from the at least one association identifier included in the element; and complete an association process with the non-access point device using the association identifier.

In one aspect, one or more non-transitory computer-readable media include computer-readable instructions, which when executed by a first access point, cause the first access point to receive, from a non-access point device, a request, wherein the request includes an element to signal to the first access point to exclude each of at least one association identifier indicated by the element when assigning an association identifier to the non-access point device; assign the association identifier to the non-access point device, wherein the association identifier is different from the at least one association identifier included in the element; and complete an association process with the non-access point device using the association identifier.

### Example Embodiments

802.11 silicon vendors (on behalf of themselves or their system-vendor customers) wish to add proprietary PHY-layer features to Physical Protocol Data Units (PPDUs) and have them understood by their other products and not confuse third party devices. For instance, silicon vendors (e.g., Qualcomm, Broadcom, etc.) might support higher modulation orders, new Forward Error Correction (FEC) codes, how best to apply channel smoothing for x1/x2 Long Training Fields (LTFs), additional features for improved ranging, that the transmitter has particularly low Error Vector Magnitude (EVM), that the transmitter has particularly low phase noise, the presence of constellation shaping, etc., all of which are non-limiting examples of vendor specific (VS) features (may also be referred to as VS behavior).

There are already reserved bits in the PHY header (SIG) fields. However, these are non-robust, especially for future amendments, because different implementers are already using these bits in different ways for their own vendor specific features.

Implementers enable their vendor-specific feature after vendor-specific upper-layer agreements (e.g., VS element in Beacon/Probe Response and Association Response for the AP (MLD) and Probe Request and Association Request for the non-AP STA). The mapping between PPDU and agreement can be via BSS Color (unreliable) and Association Identifier (AID) (more reliable) and taking into account that there is little cost to a non-intended recipient of a PPDU being confused by the VS features (such as receiving the PPDU as if the PPDU is for the non-intended recipient without VS features, mis-decoding the PPDU, getting a bad Frame Check Sequence (FCS) and invariably a mismatched Receiver Address (RA) as well), and then dropping the bad frames.

However, complexities arise in situations where a client device (e.g., a mobile device having multiple STAs) is a client of multiple access points with (1) at least one of the access points being associated with one VS signaling while at least one other access points is not, or (2) each access point being associated with a different VS signaling. In such scenario, unique PPDU identification for each access point, for purposes of negotiating VS signaling, is desirable because otherwise, an STA may receive VS PPDU from an access point that the STA should not otherwise receive, which then results in the STA being unable to receive corresponding PHY Layer Convergence Protocol (PLCP) Service Data Unit (PSDU) due to lack of ability to implement vendor specific PHY features.

As a non-limiting example, consider a device (e.g., a smartphone) having two virtual STAs, referred to as VSTA1 and VSTA2, that may associate with two different APs (e.g., AP1 that may be a access point offering vendor specific features and AP2 that may offer either another vendor's vendor-specific features or no vendor specific features, such as, a wireless dock, a smart TV, another smartphone, a laptop, etc. (typically any device other than an infrastructure access point).

AP1 and VSTA1 may be associated with a particular vendor (e.g., Broadcom) and are therefore configured to negotiate use of Broadcom's VS behavior when communicating with each other. When associating with AP1, VSTA1 may be assigned AID1. Therefore, PPDUs that include AID1 signal the presence of proprietary and VS features coming from AP1.

At the same time, AP2 may not use Broadcom vendor-specific features and instead may use a different feature-set (e.g., either generic or associated with another vendor such as, for example, Qualcomm, Mediatek, etc.). If the same AID1 is assigned to VSTA2 when associating with AP2, that will cause the underlying STA hardware supporting VSTA1 and VSTA2 to determine that a PPDU with a STAID (STA Identifier) corresponding to that AID1 received by the underlying hardware could be from AP1 with Broadcom VS features or could be from AP2 without VS features or with a different vendor's VS features. The underlying hardware has no way to determine what PHY processing to apply. This may be referred to as a PPDU identification problem and the present disclosure is directed to providing a solution to ensure proper identification of PPDUs with different VS behaviors.

These problems are exacerbated with the development of Universal Signal (U-SIG) that is part of the PHY header with a PPDU because (1) U-SIG is intended to support many generations of 802.11 MAC/PHY amendments and many vendors/eco-systems and (2) any misuse of reserved fields or VS-redefinition of standardized fields runs the risk that the misuse/redefinition will be exposed in future amendments. Therefore, any solution to ensure proper PPDU identification with different VS behaviors should also minimize any PHY layer changes in this sensitive field.

There may be several options available to ensure proper PPDU identification with different VS behaviors while minimizing PHY layer changes. These options include, but are not limited to, BSS coloring, using reserved U-SIG bits, defining and using new VS SIG field, using AID, using padding bits in Ultra High Rate Signal (UHRSIG), transmitting information in the null subcarriers of the Ultra High Throughput Long Training Field (UHTLTF), using the Service filed, and/or using the PHY pad bits in the Data field. One exemplary advantageous option from among these options is the use of AIDs to ensure proper PPDU identification with different VS behaviors.

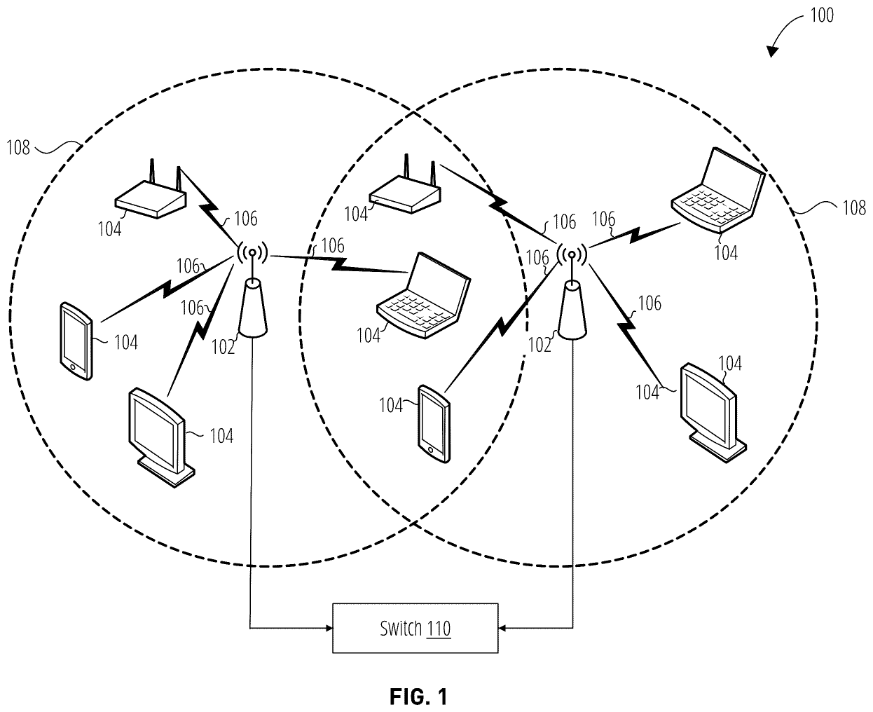

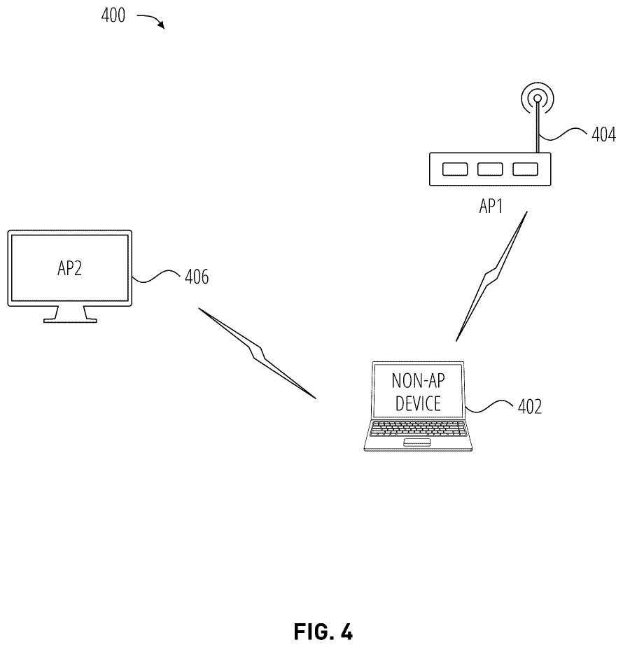

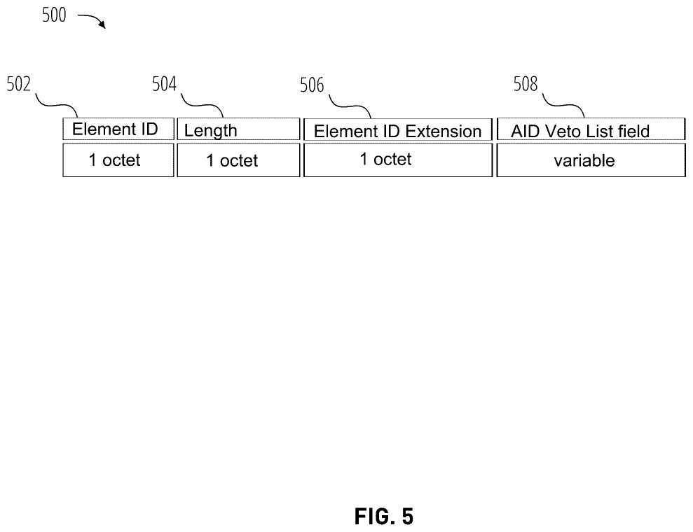

Example embodiments described herein are directed to proper PPDU identification with different VS behaviors through unique AIDs and thence STAIDs. This will be further described below with reference to FIGS. 4 and 5. Before doing so, exemplary and non-limiting examples of wireless communication networks (which can be MLO based or not), will be described with reference to FIGS. 1-3.

FIG. 1 illustrates a block diagram of an example wireless communication network according to some aspects of the present disclosure. According to some aspects, the wireless communication network 100 may be an example of a wireless local area network (WLAN) such as a Wi-Fi network. For example, the wireless communication network 100 may be a network implementing at least one of the IEEE 802.11 family of wireless communication protocol standards and amendments thereof (such as that defined by the IEEE 802.11-2016 specification or amendments thereof including, but not limited to, 802.11ay, 802.11ax, 802.11az, 802.11ba and 802.11be). Additionally, the wireless communication network 100 may implement future versions and amendments of the wireless communication protocol standards and amendments thereof such as 802.11bn and be modified according to the present disclosure to include the features contained herein. The wireless communication network 100 may include numerous wireless communication devices such as an AP actor, which can be one or more of a non-MLD AP, an AP affiliated with an AP MLD, and/or an AP MLD. In the examples presented herein, the AP actor can exclude an upper UMAC. Therefore, the AP actor can include the lower UMAC, LMAC, and/or PHY. Additionally, the WLAN can include one or more of STA actors 104, which can be one or more of a non-MLD STA, a STA affiliated with a non-AP MLD, and/or a non-AP MLD. As illustrated, the wireless communication network 100 also may include multiple AP actors such as AP actors 102 (may also be referred to as simply AP). The AP actors 102 can be coupled to one another through a switch 110. While the AP actors 102 are shown as being coupled to one another through a switch 110, the network can provide another device that allows the coupling of the multiple AP actors.

Each of the STA actors 104 also may be referred to as a mobile station (MS), a mobile device, a mobile handset, a wireless handset, an access terminal (AT), a user equipment (UE), a subscriber station (SS), client, or a subscriber unit, among other examples. The STA actors 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples. In other examples, the STA actors 104 can be referred to as clients and/or client devices.

Any one of the AP actors 102 and an associated set of STA actors (e.g., STA actors 104) may be referred to as a basic service set (BSS), which is managed by a respective AP actor of AP actors 102. FIG. 1 additionally shows an example coverage area 108 of the each of the AP actors 102, which may represent a basic service area (BSA) of the wireless communication network 100. As illustrated, three of the STA actors 104 are within the BSA of each of the AP actors 102. The BSS may be identified to users by a service set identifier (SSID), where the BSS might be one of many in the SSID. The BSS may be identified to other devices by a unique (or substantially unique) basic service set identifier (BSSID). One or more of the AP actors 102 periodically broadcasts beacon frames (“beacons”) including the BSSID to enable STA actors 104 within wireless range of the AP actors 102 to “associate” or re-associate with the AP actors 102 to establish a respective communication link of communication links 106 (hereinafter also referred to as a “Wi-Fi link”), or to maintain the communication links 106, with the AP actors 102. For example, the beacons may include an identification of a primary channel used by the respective AP actor of AP actors 102 as well as a timing synchronization function for establishing or maintaining timing synchronization with the AP actors 102. The AP actors 102 may provide communication links 106 to the STA actors 104 and therefore access to external networks. While the example has been described in regard to the AP actors 102 and STA actors 104, the present disclosure extends such that an AP actor may provide access to external networks to various STA actors in a WLAN via the communication links 106.

To establish the communication links 106 with any one of the AP actors 102, each of the STA actors 104 is configured to perform passive or active scanning operations (“scans”) on frequency channels in one or more frequency bands (for example, the 2.4 GHz, 5 GHZ, 6 GHz or 60 GHz bands). To perform passive scanning, the STA actors 104 listen for beacons, which are transmitted by a respective AP actor of AP actors 102 at or near a periodic time referred to as the target beacon transmission time (TBTT) (measured in time units (TUs) where one TU may be equal to 1024 microseconds (μs)). To perform active scanning, the STA actors 104 generate and sequentially transmits probe requests on each channel to be scanned and listens for probe responses from AP actors 102. The STA actors 104 may be configured to identify or select an AP and thence a selected AP actor of AP actors 102 with which to associate based on the scanning information obtained through the passive or active scans, and to perform authentication and association operations to establish the communication links 106 with the selected AP actor of AP actors 102. The selected AP actor of AP actors 102 assigns an association identifier (AID) to the STA actors 104 at the culmination of the association operations, which the selected AP actor of AP actors 102 uses to improve the efficiency of certain signaling to the STA actors 104.

The present disclosure modified the WLAN radio and baseband protocols for the PHY and medium access controller (MAC) layers. The AP actors 102 and STA actors 104 transmit and receive wireless communications (hereinafter also referred to as “Wi-Fi communications”) to and from one another in the form of PHY protocol data units (PPDUs). The AP actors 102 and STA actors 104 also may be configured to communicate over other frequency bands such as shared licensed frequency bands, where multiple operators may have a license to operate in the same or overlapping frequency band or bands.

Each PPDU is a composite structure that includes a PHY preamble and a payload in the form of one or more PHY service data unit (PSDU). The information provided in the preamble may be used by a receiving device to decode the subsequent data in an intended PSDU. In instances in which PPDUs are transmitted over a bonded channel, selected preamble fields may be duplicated and transmitted in each of the multiple component channels.

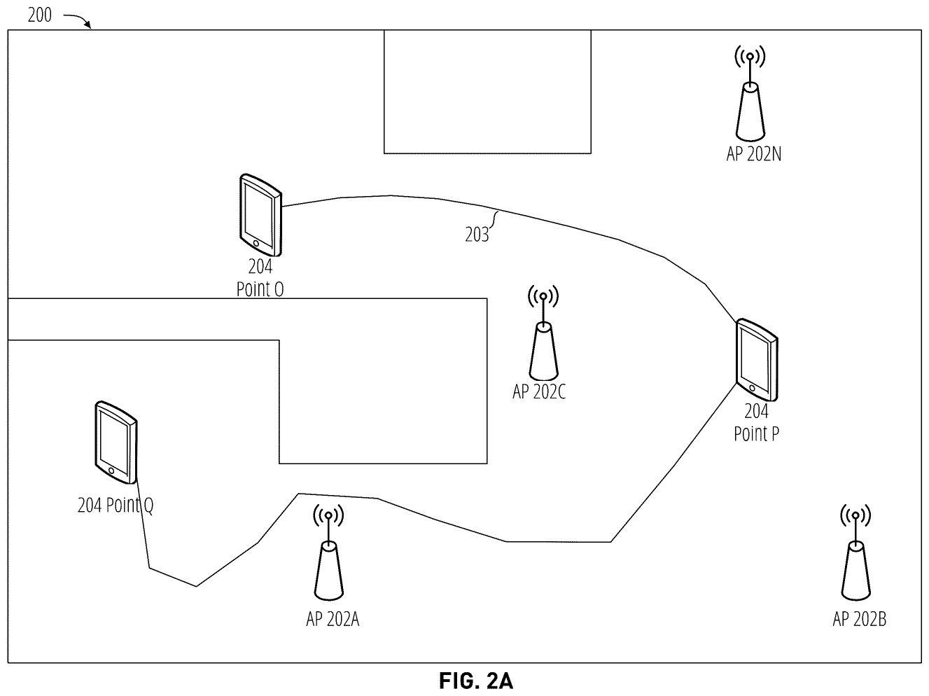

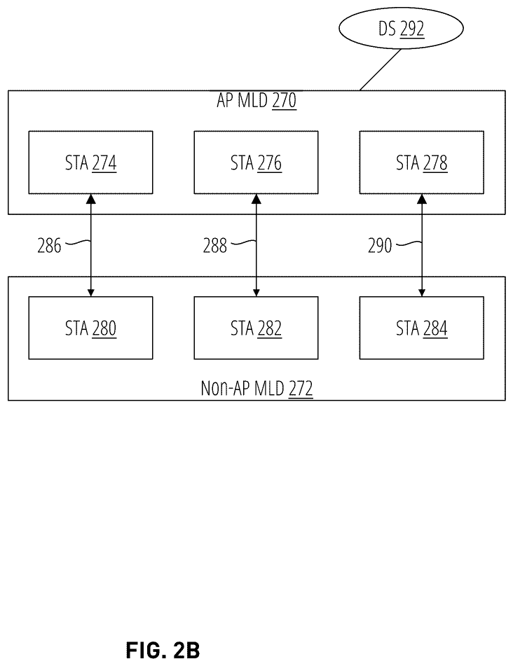

FIG. 2A illustrates an example of a single floor of building equipped with wireless communication according to some aspects of the present disclosure. While only a single floor 200 is illustrated a description equally applies to multiple floors in a building. Additionally, some of the floors in a building may not be contiguous, such that floors 1, 3, 4, and 8 span a network for a building that has floors 1-10. Thus, in at least one implementation the building can include one or more floors that do not have a network including one or more AP actors. As illustrated, the single floor 200 includes AP actors 202A, 202B, 202C, . . . , 202N. Each of the AP actors 202A, 202B, 202C, . . . , 202N can have a respective coverage area such that an overall coverage area can span substantially the entire floor. In other examples, the overall coverage area can extend beyond the entire floor. In other examples, the overall coverage area can extend beyond the entire floor. Additionally, the coverage of an AP actor of AP actors 202A, 202B, 202C, . . . , 202N may substantially overlap with the coverage of another AP actor of the AP actors 202A, 202B, 202C, . . . , 202N.

As illustrated by the line 203, STA actor 204 can move from point O to point P to point Q. When a STA actor 204 is moving around on a given floor, one or more of the AP actors 202A, 202B, 202C, . . . , 202N can be considered to be nearest to the STA actor 204. Nearest as used in relation to the AP actors 202A, 202B, 202C, . . . , 202N and STA actor 204 can include being physically nearest (for example, a Euclidean distance on the floor) and/or pathloss-nearest (for example, having the lowest wireless attenuation (pathloss) between AP actor, among all the AP actors, and STA actor). Additionally, the pathloss-nearest approach can be used to reduce the likelihood of connection between an AP actor on a floor above or below the STA actor 204. The location of the AP actor on the floor above or below might be closer in a Euclidean sense, but also not be a desirable AP for the connection of the device or station due to the floor location and/or possible signal interruption. The location of the AP actor on the floor above or below might be closer in a straight line and/or Euclidean sense, but also not be a desirable AP for the connection of the device or station due to the floor location and/or possible signal interruption. Additionally, the coverage of one or more AP actors can at least partially overlap with the coverage of one or more other AP actors. The present disclosure provides for selecting the AP actor and/or providing a communication pathway from one or more STA actors through one or more AP actors.

FIG. 2B depicts an illustrative schematic diagram for MLO between an AP MLD with affiliated logical entities and a Non-AP MLD with affiliated logical entities according to some aspects of the present disclosure.

Referring to FIG. 2B, two multi-link logical entities AP MLD 270 and Non-AP MLD 272 are shown. AP MLD 270 may include physical and/or logical affiliated AP such as AP 274, AP 276, and AP 278 operating in different channels and typically different frequency bands (e.g., 2.4 GHz, 5 GHZ, and 6 GHZ). AP 274, AP 276, and AP 278 may be the same as or similar to any one of the APs described above. Non-AP MLD 272 may include STA 280, STA 282, and STA 284, which may be the same as or similar to any of the STAs as described herein.

AP 274 may communicate with STA 280 via link 286. AP 276 may communicate with STA 282 via link 288. AP 278 may communicate with STA 284 via link 290.

AP MLD 270 is shown in FIG. 2B to have access to a distribution system (DS) such as DS 292, which is a system used to interconnect a set of BSSs to create an extended service set (ESS).

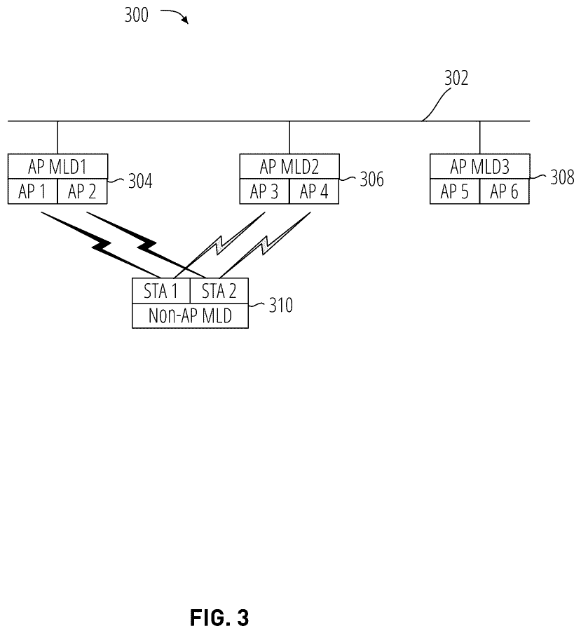

It should be understood that although the example shows three logical entities within the AP MLD and the three logical entities within the Non-AP MLD, this is merely for illustration purposes and that other numbers of logical entities within each of the AP MLD and Non-AP MLD may be envisioned. The example Wi-Fi systems and MLO described above with reference to FIGS. 1 and 2A-B provide examples of simplified and example systems of the present disclosure. Additional details of the present disclosure are provided in relation to FIGS. 3, 4, and 5.

FIG. 3 illustrates an example of a seamless mobility domain according to some aspect of the present disclosure.

FIG. 3 illustrates an example architecture of a Seamless Mobility Domain (SMD) shown as SMD 300 that includes a DS 302 (may be the same as the DS 292) that is a logically connected entity that includes AP MLD1 304, AP MLD2 306, and AP MLD3 308, all of which can form an ESS (e.g., all AP MLDs which are part of a campus ESS network). The SMD 300 also shows a non-AP MLD 310 that may be connected to AP MLD1 304.

AP MLD1 304 may include one or more APs such as AP1 and AP2. AP1 and AP2 may be different physical APs (or AP interfaces) co-located in AP MLD1 304. Similarly, AP MLD2 306 may include one or more APs such as AP3 and AP4. AP3 and AP4 may be different physical APs (or AP interfaces) co-located in AP MLD2 306. Similarly, AP MLD3 308 may include one or more APs such as AP5 and AP6. AP5 and AP6 may be different physical APs (or AP interfaces) co-located in AP MLD3 308. The number of AP MLDs and/or the number of respective APs of each AP MLD is not limited to the example numbers shown in FIG. 2B and may include more or less.

In one example, AP MLD1 304, AP MLD2 306, and AP MLD3 308 may be located in different geographical locations (e.g., different rooms of the same building, different floors of the same building, different buildings of the same campus or area, etc.).

Non-AP MLD 310 may be any known or to be developed device capable of establishing one or more wireless communication links with one or more of AP MLD1 304, AP MLD2 306, and/or AP MLD3 308. As a non-limiting example, non-AP MLD 310 may be a mobile device having two wireless interfaces, each of which may correspond to one of STA 1 or STA 2. In one example, each one of STA 1 and STA 2 may operate on a different link (e.g., 5 GHz for STA 1 and 6 GHz for STA 2). The number of Non-AP MLDs and/or STAs associated with each is not limited to that shown in FIG. 3 and may be more or less.

As shown in FIG. 3, the non-AP MLD 310 is associated with the SMD 300 with multiple links setup with the AP MLD1 304 (for example, 2.4 GHz link with the AP1 for the STA 1 and 5 GHz link with the AP2 for the STA 2). For one of the links (for example, 2.4 GHz), the AP MLD 304 may detect a weak RSSI. As a result, the non-AP MLD 310 determines a specific roaming target AP3 of AP MLD2 306 for that link to switch to. Similarly, the same process may be performed for the other link (for example, the 5 GHz) to switch to a link with STA 4 on the AP MLD2 205.

In order to support seamless link level roaming for an ESS/NID/MDM/SMD (e.g., for MBBR), by way of an example, seamless link level roaming may be initiated by the current AP MLD (e.g., AP MLD1 304). Alternatively, seamless link level roaming may be based upon a request received from the Non-AP MLD (e.g., non-AP MLD 310). The current AP MLD (may also be referred to as the source ap MLD) may send a frame, for example, a BSS Transition Management Request frame or any other known or to be developed management frame, to indicate to the Non-AP MLD one or more of: a) one or more ‘delete link’ operations for link(s) of the current AP MLD (in the old MLD's link ID space); and/or b) one or more ‘add link’ operations for link(s) of a new Target AP MLD such as the AP MLD2 306 (in the new MLD's link ID space), wherein the current AP MLD may indicate ‘add link’ operations for multiple candidate Target AP MLDs.

As described herein, the link space can be defined and identified corresponding to each AP MLD by the respective AP MLD MAC Address field included in the Reconfiguration ML element. Accordingly, the frame, such as the BSS Transition Management Request frame, may include multiple Reconfiguration Multi-Link elements. Each Reconfiguration Multi-Link element of the multiple Reconfiguration Multi-Link elements corresponds with each AP MLD for which either a link add, or a link delete operation is indicated in the frame. Further, as described herein, the link add operation may be indicated for multiple roaming candidate Target AP MLDs within the Link Reconfiguration Notify frame. In the Reconfiguration Multi-Link element, the MLD MAC Address may be set to the MLD MAC Address of the AP MLD for which the link add or the link delete operation is indicated.

Support for seamless/smooth roaming capability is a consideration for Wi-Fi 8 to improve Wi-Fi roaming quality. To support smooth roaming/mobility in network (e.g., a geographically dispersed network such as on a campus wide Wi-Fi network), clients can create association with the campus-network/ESS instead of with an individual AP MLD. The ESS might be represented by a mobility domain or, in the case that the network is a global network, then there can be multiple “sub-mobility domains” within a mobility domain, each of which can map to a single campus.

A client such as the non-AP MLD 310 currently creates its association with the ESS network such as the SMD 300, instead of associating with a single AP MLD (e.g., AP MLD1 304, AP MLD2 306, and/or AP MLD3 308) within the ESS. Such an architecture will enable a client to roam seamlessly between AP MLDs without requiring (re) association and reestablishment of contexts with each new AP MLD, since the client associates with the SMD covering all the AP MLDs of the ESS. Such an architecture can significantly reduce roaming time to realize seamless roaming. Signaling procedures to enable such seamless roaming are described in the present disclosure.

In Wi-Fi 7/802.11be, a Non-AP MLD associates with an AP MLD according to known or to be developed procedures. In Wi-Fi 8, a Non-AP MLD associates with an SMD (e.g., SMD 300) or SMD MLD (or NID or MDM) that cover multiple APs/AP MLDs of an ESS. In a Distributed MLO architecture for seamless roaming, multiple AP MLDs that are part of an SMD/SMD MLD would have a common Upper MAC (U-UMAC) that provides a single MAC SAP to the DS covering the multiple APs/AP MLDs of the SMD/SMD MLD. In such a Distributed MLO architecture, a non-AP MLD can have link setup with one or more AP MLDs within an SMD/SMD MLD.

For both cases (Wi-Fi7 and Wi-Fi 8), the present disclosure introduces a mechanism to enable switch link operation to switch a current link to a new link (either within an AP MLD or across two AP MLDs) atomically. An atomic switch link operation may be defined as one where the entire operation either succeeds fully or is not executed (e.g., a delete link operation and an add link operation succeed together or else none would be carried out). This ensures that the Non-AP MLD would not end up in a situation where its current link got deleted, but the new link did not get added to its ML setup (e.g. because the AP or the associated link is already too crowded and a new STA can't be accepted on that link). This will be described in more detail below.

The 802.11be amendment defines the Link Reconfiguration Request/Response frames for add link and delete link operations. Using this, as described herein, a switch link operation can be achieved by including both delete link and add link within the same request frame.

In currently implemented/adopted procedures, the existing AP always accepts the delete link operation, not knowing the intent of the Non-AP MLD (e.g., to add a new link). The present disclosure proposes enhancements that address these deficiencies. More specifically, the proposed enhancements to the 802.11be Link Reconfiguration Request/Response signaling include providing support for an atomic switch link operation in the protocol within an AP MLD and across multiple AP MLDs (for roaming scenario).

With various examples of wireless communication networks described above, example embodiments directed to proper PPDU identification with different VS behaviors through unique AIDs will be described next, with reference to FIGS. 4 and 5.

FIG. 4 illustrates an example scenario of a non-AP device association with multiple APs according to some aspects of the present disclosure.

Example setting 400 may include non-AP device 402, AP1 404, and AP2 406. Non-AP device 402 may be any device having multiple STAs each of which may be configured to establish an independent wireless connection with a given access point. For sake of discussion non-AP device 402 may be assumed to have two virtual STAs (e.g., VSTA1 and VSTA2). Non-AP device 402 may be a non-AP MLD such as non-AP MLD 310 of FIG. 3 or any other non-AP MLD described with reference to FIGS. 1 and 2A-B. In general, a virtual STA is a virtual component that is capable of establishing a wireless connection to an access point and shares underlying its PHY-layer resources with another STA.

AP1 404 may be any known or to be developed access point. AP1 may provide wireless/internet connectivity to a network for any device associated therewith, such as a router in a building. AP1 404 may be referred to as an infrastructure access point. AP1 may also offer more limited service (e.g., no Internet connectivity) such as an AP or P2P Group Owner in a screen offering Miracast service. AP1 404 may be an access point with vendor specific features. AP1 404 may be an AP MLD such as anyone of AP MLD 304, AP MLD1 304, AP MLD2 306, and/or AP MLD3 308 of FIG. 3 or any other AP MLD described with reference to FIGS. 1 and 2A-B.

AP2 406 may be any known or to be developed P2P access point that provides P2P wireless communication with non-AP device 402. As shown in FIG. 4, AP2 406 may be a smart TV, smartphone, laptop, etc. However, example embodiments are not limited thereto and AP2 406 may be any other known or to be developed P2P access point such as a keyboard, a mouse, a streaming or mirror device, etc. AP2 might also be another infrastructure AP (where the non-AP device is connected to both such as for redundancy or for greater throughput for separate flows)

In another example, AP2 406 may be another access point similar to AP1 404 except that AP2 406 may include vendor specific (VS) features that are different than the VS features of the vendor of AP1 404 or may be an access point that does not have any vendor specific features. Accordingly, AP2 406 may be an AP MLD such as any one of AP MLD 304, AP MLD1 304, AP MLD2 306, and/or AP MLD3 308 of FIG. 3 or any other AP MLD described with reference to FIGS. 1 and 2A-B.

It should be noted that setting 400 shows a single non-AP device 402 having two example VSTAs each associating with a different one of two APs (i.e., AP1 404 and AP2 406). However, the present disclosure is not limited to setting 400 and may be equally applicable to scenarios including multiple non-AP devices each having multiple virtual STAs communicating with one or more APs.

In setting 400, non-AP device 402 is a device that is going to negotiate VS features with an AP (e.g., through association of VSTA1 with AP1 404), and thus unique assignment of AIDs is a challenge because non-AP device 402 is not an AID maker. AIDs are selected and assigned by an access point and not by a non-AP device. However, in scenarios where the device negotiating VS features is itself an access point, ensuring uniqueness of an assigned AID is not problematic because the access point itself is in charge of selecting and assigning an AID to a particular association and can hence ensure that AIDs for different associations remain unique.

For sake of discussion, an assumption is made that VSTA1 and VSTA2 each support VS PHY features defined by a vendorset. For instance, a vendorset can include [vendor1 and vendor2]. For instance, the product including VSTA1 and VTA2 might be manufactured by vendor1 and vendor 1 also licenses, for use in its products, the vendor specific features by vendor2. However, example embodiments are not limited to two vendors and may include more or less. For sake of discussion, a further assumption is made that AP1 can signal to VSTA1 and/or VSTA2 support for VS features1 of vendorset1 while AP2 can signal to VSTA1 and/or VSTA2 support for VS features2 of vendorset2.

Example embodiments described herein ensure that prior to negotiating any VS features between any AP such as AP1 404 or AP2 406 and one of VSTA1 and VSTA2, a corresponding PPDU is uniquely identifiable for VSTA1 and VSTA2 through a unique STAID (achieved in turn by a unique or substantially unique AID).

In one non-limiting example, VSTA1 of non-AP device 402 may associate (or re-associate) with AP1 404, which has advertised support for vendor specific PHY features for vendor1. As part of the association, AP1 404 assigns AID1 to VSTA1. Upon completion of the association, VSTA1 and AP1 404 negotiate use of vendor specific PHY features of vendor1 supported by AP1 404.

Thereafter, VSTA2 may send an association (or re-association) request to AP2 406. This association request by VSTA2 may include an element that identifies AID1 to ensure that AP2 406 does not assign AID1 to VSTA2. This element may be referred to as AID Veto element.

In response, AP2 406 assigns a different AID to VSTA2 (e.g., AID2). Any known or to be developed methodology for selecting a unique AID that is different than any AID indicated in an AID veto element may be utilized by AP2 406. Thereafter, VSTA2 and AP2 406 may negotiate vendor specific PHY features supported by AP2 406 (e.g., features specific to vendor2).

In one example (e.g., when, for a given VSTA, multiple AIDs have already been assigned to other VSTAs sharing the same underlying physical resources), a corresponding AID Veto element may include a list of all such “already-assigned” AIDs to ensure that no AID on the list is assigned to that given VSTA. In another embodiment, the AID Veto element is called a STAID Veto element and lists the STAIDs in use by other VSTAs sharing the same underlying physical resources. Note that a STAID may be the 11 least significant bits (B0 to B10) of an AID, where the high order bits (B11 and upwards) of an AID assigned by an AP may never or almost never be non-zero.

In one example, when multiple AIDs (e.g., AID1, . . . , AID(n)) are already assigned by other APs to other VSTAs, the process described above may be repeated equal to the number of already assigned AIDs (e.g., n times).

Through defining and including an AID Veto element in the association (or re-association) request frame, each PPDU subsequently received by a given STA can be uniquely identified. This process is equally applicable to examples where a single AP includes multiple virtual APs (e.g., as opposed to two separate physical APs as shown in FIG. 4) and e.g. one virtual AP is configured to support VS features and one virtual AP is not.

In some examples, it may be desirable for non-AP device 402 to obfuscate (hide) identities of one or more of affiliated VSTAs when a given VSTA is associating with an AP. For instance, it may be desirable for VTSA2 not to advertise use of AID1 by VSTA1. To implement such obfuscation, one or more additional AIDs (a subset of which may not be in use by this device but may be in use by other nearby devices) may be included as part of the list of AIDs in the AID Veto element in order to confuse the any recipient of the AID Veto element and make it hard to reliably connect members of P2P networks with infrastructure non-AP STAs.

In another example, in an attempt to obfuscate assigned AIDs, all STAs can change all their parameters including AIDs at the same time at epoch boundaries. Any updated AID (changed at epoch boundaries) that collides with an AID assigned by another AP can be addressed by the respective STA requesting/soliciting an updated AID. This may be a post-association process (e.g., after the initial AID assignment based on AID Veto element to all underlying STAs). Post association AID Vetoing will be described below with reference to FIG. 5.

As noted above, one of the objectives of the present disclosure is to ensure minimal PHY changes (e.g., minimal changes to PPDU format). In order to do so, after an STA is assigned a unique AID by an AP (e.g., AID1 assigned by AP1 404 to VSTA1), VSTA1 may negotiate vendor specific features/behavior with AP1 404 using upper layer signaling (e.g., MAC-level vendor specific negotiations). Any negotiated vendor specific feature cannot affect information for other STAs. For instance:
PPDUs containing Request to Send (RTS), Clear to Send (CTS), Contention Free End (CF-End) and likely Multi-User Request to Send (MU-RTS), Acknowledgement (Ack), and/or Block Acknowledgement (BA) should remain unchanged;
Legacy Short Training Field (LSTF), Legacy Long Training Field (LLTF), Legacy Signal Field (LSIG), Repeated LSIG (RLSIG), version independent fields of the USIG should remain unchanged; and
Yet-to-be-defined fields intended for third party (other) STAs should remain unchanged.

Furthermore, VS features can be static (e.g., remain the same across all PPDUs exchanged between two peers such as VSTA1 and AP1 404) or can be dynamic (e.g., change per PPDU). For static VS features negotiated with a subset of peers, the agreement (reflective of negotiated VS features) includes a mechanism for transmitting peers in the subset to identify PPDUs intended for the STA uniquely with respect to PPDUs sent by peers not in the subset. This may be achieved through the use of a unique AID and thence STAID, where uniqueness is achieved in turn via the AID Veto element described above. This requirement for static VS features remains valid for dynamic VS features, coupled with additional elements to signal any dynamic VS parameter (e.g., via per-PPDU signaling). For example, on a per-PPDU basis, redefined bit(s) or redefined values in the user field of a PPDU may be utilized to signal dynamic VS feature parameters. In another example, bits in the pad field of the UHRSIG field may carry dynamic VS parameters.

The assigning of unique AIDs to different pairings of APs and STAs described above with reference to FIG. 5 may be performed as part of an association process between a given AP and a given STA. However, AID assignment may continue to be warranted post-association (such as an operation without disrupting association or via a follow-up association) where an already-assigned AID is to be changed to a new AID. For instance, post association AID assignment (re-assignment) may be warranted at epoch boundaries as briefly mentioned above. To enable such post association AID assignment, a number of options may be utilized for AID vetoing in a post association scenario.

According to one option, a unique frame may be defined to carry an AID List Veto Element and a new corresponding response frame to carry the new AID. This can be a general-purpose method to belatedly change association parameters or defer the sending of private association parameters or parameters needing security, via new “Protected Association Request and Response frames” sent after the Four Way Handshake (4WHS).

Another option can be to reuse/extend the evolving 802.11bi mechanism for requesting a new AID.

Another option can be adding an AID change field to the Link Reconfiguration element as defined in 802.11bi.

Another option can be using an AID Switch Request frame (AID Request Element and AID Switch Response frame) from 802.11ah.

FIG. 5 illustrates an example element format to be used for pre-association AID vetoing and/or post-association AID vetoing according to some example embodiments.

Example element 500 can include several fields including element ID 502, length 504, element ID extension 506 (if needed), and AID Veto List field 508, with each field having a corresponding length (e.g., 1 octet, variable, etc., as shown in FIG. 5).

The AID Veto List field 508 can list the AIDs that a given STA (e.g., VSTA1) does not wish to have assigned as the STA's AID, and can be:
N*2 octets, where each 2 octets contain the AID; or
N*1.5 octets+0/0.5 octets of Pad bits, where each 1.5 octets contain a 12-bit or 11-bit AID.

The field might instead be called the STAID Veto List and can list the STAIDs that a given STA does not wish to use as a consequence of the AID assignment. The format of the STAID Veto List might be formatted as N*2 octets, wherein 11 bits contain a STAID and 5 bits are reserved, or N*1.5+pad octets, wherein 11 bits contain a STAID and 1 bit is reserved. In a maximally-packed format, the 11-bit STAIDs might be sent back-to-back without any intervening reserved bits, then octet-alignment padding is appended. In the following, wherever AID is referred to, it is understood that STAID might be used instead as shown here.

For post association AID vetoing, a series of management frames embodying the options described above may be exchanged between an STA and an AP. These frames can include, but are not limited to, An action frame sent by an AP (e.g., AP1 404) to a non-AP STA (e.g., VSTA1) that lists AIDs to be assigned at different epochs. An action response frame can be defined, which would be sent by the non-AP STA to the AP with an AID Veto List (per epoch), and a subsequent response frame by the AP back to the non-AP STA that reflects AIDs in compliance with the AID Veto list.

An example of an action frame may be as follows. For example, 802.11bi may define:
AP sends a message to non-AP STA: “for N epochs, starting at next epoch (e.g., starting at epoch E), the AIDs allocated to the non-AP STA are AID1, AID2, . . . . AID-N;
Frame format can be: Action (Management) frame, with Frame Body including Category=“Enhanced Data Privacy”, EDP Action=“AID Assignment”, then optionally an epoch identifier (E) (e.g. <1/1/2/4 octets), optionally N (e.g., 1 octet) (N can instead be determined from the MPDU length at the cost of future proofing), then a list of N AIDs (e.g., 2 octets per AID or a packed format with say 12 bits per AID).
   E, N and the list can optionally be sent in the frame encapsulated in an element (prefixed by element ID 502, Length 504, and (if needed) element ID Extension 506, as shown in example element 500 of FIG. 5).

An example of an action response frame may be as follows. For example, UHR can define:
Non-AP STA message to the AP: “the STA vetoes the following AIDs at each epoch.”
Frame format can be: Action Response (Management) frame, with Frame Body including Category=“Enhanced Data Privacy”, EDP Action=“AID Assignment Veto”, then optionally an epoch identifier (E) (e.g. <1/1/2/4 octets), then the “vetoed AIDs at each epoch”
Many encodings are possible for “vetoed AIDs at each epoch”. Since the veto list should be a sparse list, the list can be:
   Optionally N (e.g. 1 octet), then list of N (epoch ID=0.5/1/1.5/2//2.5/3.5/4 octets, vetoed AID=1.5/2 octets each) tuples where the epoch ID may repeat across tuples;
   #Tuples (e.g., 1 octet), then list of (epoch ID, N (e), list of N (e) vetoed AIDs) tuples, where N (e) encodes the length of list of vetoed epoch IDs, and varies each epoch e; N (e) never indicates 0; N (e) could be 0.5/1 octet; see above for Epoch ID & AID lengths;
   List (one entry per epoch) of (N (e), list of N (e) vetoed AIDs) tuples;
   Alternatively, instead of having N (e) then a list of N (e) vetoed AIDs in the options above, we could have a list of AID+Continuation fields, wherein the AIDs are confined to 15 bits (e.g., 15b of AID, or 14b of AID+1 reserved bit) and there is 1b of Continuation (e.g., the Most Significant bit (MSB)). Continuation is set to 1 to indicate that the list of vetoed AIDs continues, and set to 0 to indicate that the this is the last AID in the list (or switch 0 and 1);
   Alternatively, the list of vetoed AIDs could be encapsulated in an element (prefixed by element ID 502, Length 504 (akin to N (e)), and (if needed) element ID Extension 506, as shown in example element 500 of FIG. 5).

An example of a follow up response reflective of compliance of the AP with AID Veto list can be as follows. In response, the AP can provide a new set of AIDs in different ways (e.g., changes only, or report the entire set of AIDs again). To avoid having to define a new frame format, the AP can reuse the original “AID Assignment” action frame described above, with the sporadic vetoed AIDs replaced by new AIDs that were not previously vetoed.

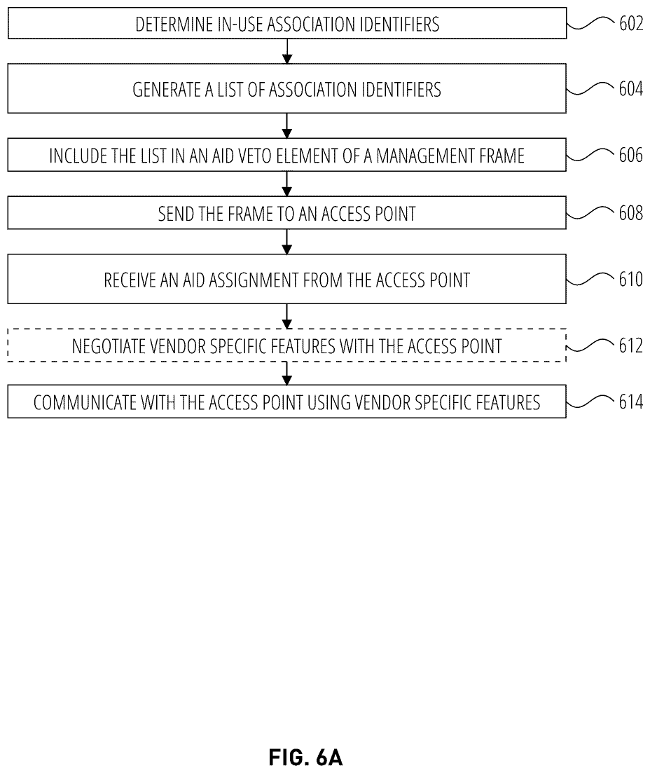

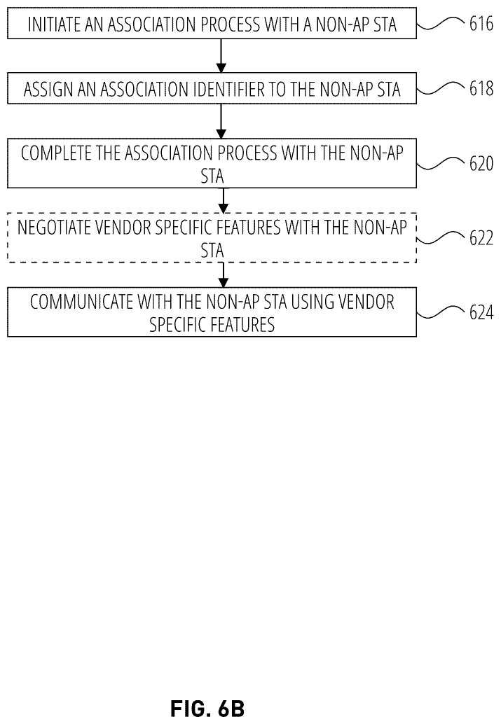

FIG. 6A illustrates a method of ensuring unique AID assignment to non-AP STAs according to one aspect of the present disclosure. FIG. 6A will be described from the perspective of a non-AP STA (e.g., VSTA2 of non-AP device 402 of FIG. 4). It should be understood that non-AP device 402 may have one or more memories having computer-readable instructions stored therein and one or more processors configured to execute the computer-readable instructions to perform functionalities described herein with reference to FIG. 6A. In the context of example scenario of FIG. 4, an assumption is made that VSTA2 of non-AP device 402 is attempting to associate with AP2 406. However, the present disclosure is not limited thereto and the process of FIG. 6A can similarly be carried out by VSTA1 of non-AP device 402 when associating with AP1 404.

At block 602, VTSA2 of non-AP device 402 determines in-use AIDs. For instance, non-AP device 402 may have other STAs (e.g., VSTA1) having already been assigned AID(s) by other AP(s) (e.g., AID1 by AP1 404). In another example, non-AP device 402 may receive an initial management frame from AP2 406 identifying available AIDs for use and assignment to VSTA2. This initial management frame may be sent as part of post-association scheduled re-assignment (change) of AIDs at different epochs, as described above.

Based on known, in-use AIDs, at block 604, VSTA2 of non-AP device 402 generates a list of AIDs that includes in-use AIDs by other VSTAs using the same underlying physical resources as VSTA2, as determined at block 602.

At block 606, VSTA2 of non-AP device 402 generates an AID Veto element as described above that includes the list generated at block 602. This AID Veto element may be the same as that described above with reference to FIG. 5.

At block 608, VSTA2 of non-AP device 402, send a management frame (a request) that includes the AID Veto element generated at block 606. This management frame can be any known or to be developed management frame. Such management frame may be referred to as an association frame, an association response frame, etc. In some embodiments the AID Veto List field is included directly in the frame (i.e., without any Element ID, Length and Element ID Extension fields)

At block 610, VSTA2 of non-AP device 402 may receive a response frame from AP2 406 that assigns an AID that is different from any AID included on the list in the AID Veto List field in the AID Veto element.

At block 612, VSTA2 of non-AP device 402 may negotiate vendor specific features (e.g., vendor specific features of vendor2 described above with reference to FIGS. 4 and 5) with AP2 406, in a similar manner as described above. In one example, the operation at block 612 may be optional because AP2 406 and/or VSTA2 may not be specific to any particular vendor.

At block 613, VSTA2 of non-AP device 402 determines a STAID associated with the AID in order to determine the vendor specific features associated with non-AP device 402.

At block 614, VSTA2 of non-AP device 402, using the STAID determined at block 613, communicates with AP2 406 using the AID (e.g., AID2) assigned thereto at block 610. Using this unique AID, VSTA2 is able to uniquely identify PPDUs received from AP2 406 and perform underlying vendor specific parameters and functionalities as identified by negotiated vendor specific features.

FIG. 6B illustrates a method of ensuring unique AID assignment to non-AP STAs according to one aspect of the present disclosure. FIG. 6B will be described from the perspective of AP2 406. It should be understood that AP2 406 may have one or more memories having computer-readable instructions stored therein and one or more processors configured to execute the computer-readable instructions to perform functionalities described herein with reference to FIG. 6B. In the context of example scenario of FIG. 4, an assumption is made that VSTA2 of non-AP device 402 is attempting to associate with AP2 406. However, the present disclosure is not limited thereto and the process of FIG. 6A can similarly be carried out by VSTA1 of non-AP device 402 when associating with AP1 404.

At block 618, AP2 406 (first access point) may initiate a process (may be referred to as a Unique AID Assignment process) with VSTA2 of non-AP device 402. In one example, this initiation may be triggered when AP2 406 receives an association request from VSTA2 of non-AP device 402, which include an AID Veto element that identifies (signals to AP2 406) at least one AID (or STAID and then implicitly a set of AIDs) to exclude when assigning an AID to VSTA2 of non-AP device 402 (e.g., AID1 assigned by AP1 404 (second access point) to VSTA1 of non-AP device 402).

In another example, initiating the Unique AID Assignment includes sending, as part of a management frame, a list of available AIDs to VSTA2 of non-AP device 402. This may occur as described above with reference to a post-association AID assignment. In this instance, and in response to sending the list of available AIDs, AP2 406 may receive a response frame from VSTA2 of non-AP device 402 that includes an AID Veto element (or multiple elements) identifying at least one AID (e.g., of AIDs included in the list sent by AP2 406) to exclude when assigning an AID to VSTA2 of non-AP device 402. The exclusion may pertain to a particular epoch, and there may be similar exclusions indicated for multiple epochs.

At block 620, AP2 406 may assign an AID to VSTA2 of non-AP device 402 that is compliant with the AID Veto element (e.g., an AID that is different from any AID included in the AID Veto element received from VSTA2 of non-AP device 402). This signaling and processing may pertain to one epoch, and may be repeated for multiple epochs, either via one frame exchange for all epochs presently being signaled or a sequence of frame exchanges, one per epoch.

At block 622, AP2 406 may complete the Unique AID Assignment with VSTA2 of non-AP device 402 according to any known or to be developed methods. This step may include the AP (MLD) sending a frame to the non-AP STA (or non-AP MLD) to report the newly assigned and unique AIDs.

At block 624, AP2 406 may negotiate vendor specific features (e.g., vendor specific features of vendor2 described above with reference to FIGS. 4 and 5) with VSTA2 of non-AP device 402, in a similar manner as described above. In one example, the operation at block 622 may be optional because AP2 406 and/or VSTA2 may not be specific to any particular vendor.

At block 626, AP2 406 communicates with VSTA2 of non-AP device 402 using the AID (e.g., AID2) assigned thereto at block 610. Using this unique AID, VSTA2 is able to uniquely identify PPDUs received from AP2 406, extract any per-PPDU signaled vendor specific parameters and perform (take advantage of) the VS features as identified by negotiated vendor specific features and per-PPDU signaled vendor specific parameters.

Example embodiments described above provide the following non-limiting advantages.

802.11 provides certain PHY resources (USIG fields, UHRSIG Common field, User fields, UHTSIG pad field, Service field, etc.). Each time a vendor (e.g., Broadcom) uses one of these PHY resources without proper guardrails, practically the PHY resources become unavailable to future amendments. Proper guardrails for PHY VS signaling, proposed in this disclosure include:
All PHY VS behaviors are to be first negotiated with a peer using upper layer signaling (e.g., MAC-level vendor-specific negotiation).
A STA does not negotiate, and shall tear down any successful negotiations for, VS behaviors before the STA as a recipient cannot distinguish between intended PPDUs with a VS behavior different to other intended PPDUs (due to assignment of same AID or assignment of different AIDs leading to the same STAID):
   For instance, for UHR (SU)/MU PPDUs, the recipient device of VS behavior with a peer shall ensure that the STAID in use with the peer is different from the STAID in use with other peers not using that VS behavior;
   Via AID allocation (if AP) and/or AID Veto (if non-AP STA), as described above.
For UHR TB PPDUs, VS dynamic signaling may occur in the Service field.
For UHR (SU)/MU PPDUs, VS dynamic signaling may occur in the User field and/or the UHR SIG pad field.
It is possible to allocate a small number of agreed USIG bits are allocated for VS purposes.
All such VS signaling operates so that it does not preclude standardized use of the same signaling resources (with the possible exception for a small number of USIG bits described immediately above).

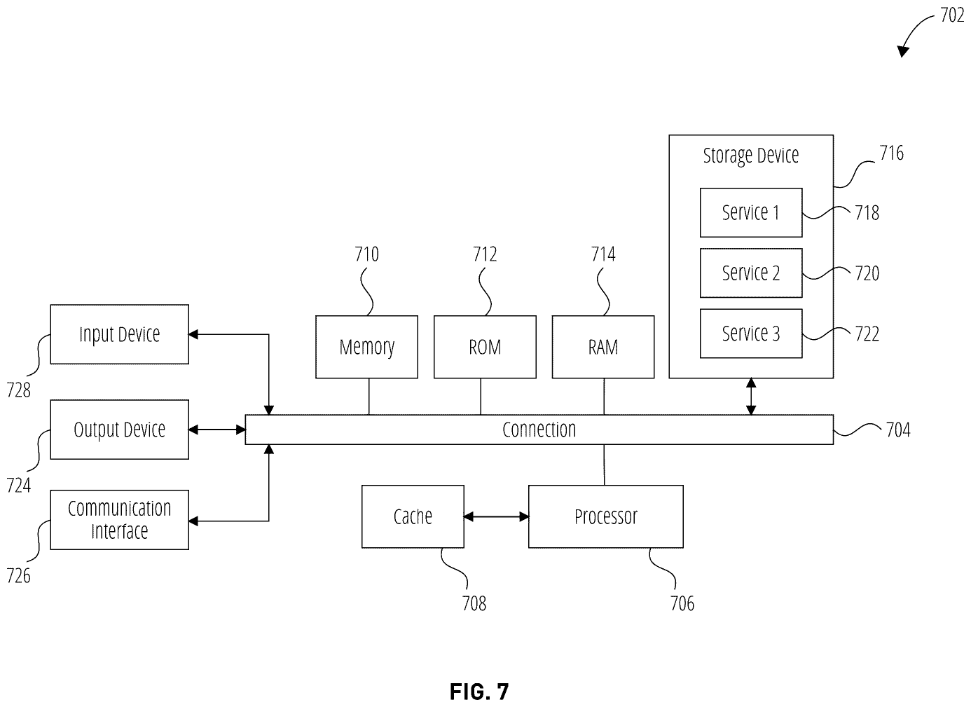

FIG. 7 shows an example of computing system according to some aspects of the present disclosure. Computing system 702 can be for example any computing device making up any of the devices described above with reference to FIGS. 1-6A-B (e.g., Non-AP MLD 310, AP MLD1 304, AP MLD2 306, AP MLD3 308, AP1 404, AP2 406, non-AP device 402, etc.). Components of computing system 702 system are in communication with each other using connection 704. Connection 704 can be a physical connection via a bus, or a direct connection into processor 706, such as in a chipset architecture. Connection 704 can also be a virtual connection, networked connection, or logical connection.

In some embodiments, computing system 702 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 702 includes at least one processing unit (CPU) or processors 706 and connection 704 that couples various system components including system memory 710, a read-only memory (ROM) such as ROM 712, and a random-access memory (RAM) such as RAM 714 to processor 706. Computing system 702 can include a cache 708 of high-speed memory 710 connected directly with, in close proximity to, or integrated as part of processor 706.

Processor 706 can include any general-purpose processor and a hardware service or software service, such as service 1 718, service 2 720, and service 3 722 stored in storage device 716, configured to control processor 706 as well as a special-purpose processor where software instructions are incorporated into the actual processor design. Processor 706 may essentially be a completely self-contained computing system, containing multiple cores or processors, a bus, memory controller, cache, etc. A multi-core processor may be symmetric or asymmetric.

To enable user interaction, computing system 702 includes an input device 728, which can represent any number of input mechanisms, such as a microphone for speech, a touch-sensitive screen for gesture or graphical input, keyboard, mouse, motion input, speech, etc. Computing system 702 can also include output device 724, which can be one or more of a number of output mechanisms known to those of skill in the art. In some instances, multimodal systems can enable a user to provide multiple types of input/output to communicate with computing system 702. Computing system 702 can include communication interface 726, which can generally govern and manage the user input and system output. There is no restriction on operating on any particular hardware arrangement, and therefore the basic features here may easily be substituted for improved hardware or firmware arrangements as they are developed.

Storage device 716 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 716 can include software services, servers, services, etc., that when the code that defines such software is executed by the processor 706, it causes the system to perform a function. In some embodiments, a hardware service that performs a particular function can include the software component stored in a computer-readable medium in connection with the necessary hardware components, such as processor 706, connection 704, output device 724, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
receiving, at a first access point and from a non-access point device, a request, wherein the request includes an element to signal to the first access point to exclude each of at least one association identifier indicated in the element when assigning an association identifier to the non-access point device;
assigning the association identifier to the non-access point device, wherein the association identifier is different from each of the at least one association identifier indicated in the element; and
completing an association process with the non-access point device using the association identifier.

2. The method of claim 1, wherein,
the non-access point device includes two or more virtual stations, and
the request is received from a first virtual station of the two or more virtual stations.

3. The method of claim 2, wherein at least one association identifier indicated in the element is a corresponding association identifier used by a second virtual station of the two or more virtual stations associated with a second access point.

4. The method of claim 3, wherein,
the first access point supports a first vendor specific physical layer features and the second access point supports a second vendor specific physical layer features,
at least one of the first access point or the second access point does not support any vendor specific features, or
the first access point supports a first vendor specific physical layer features, the second access point supports a second vendor specific physical layer features, and the non-access point device supports the first vendor specific physical layer features only.

5. The method of claim 1, wherein the element includes a plurality of association identifiers, one of which corresponds to an already in-use association identifier used by a different virtual station of the non-access point device to associate with a second access point.

6. The method of claim 1, wherein,
the request is an initial association request when the non-access point device attempts to associate with the first access point for a first time, or
the request is a follow up association identifier uniqueness request when the non-access point device attempts to change from a previously assigned association identifier to the association identifier.

7. The method of claim 1, wherein the element directly identifies the at least one association identifier, or implicitly identifies the at least one association identifier via a station identifier (STAID) associated with the non-access point device.

8. An access point comprising:
one or more memories having computer-readable instructions stored therein; and
one or more processors configured to execute the computer-readable instructions to:
receive, from a non-access point device, a request, wherein the request includes an element to signal to the access point to exclude each of at least one association identifier indicated by the element when assigning an association identifier to the non-access point device;
assign the association identifier to the non-access point device, wherein the association identifier is different from the at least one association identifier included in the element; and
complete an association process with the non-access point device using the association identifier.

9. The access point of claim 8, wherein,
the non-access point device includes two or more virtual stations, and
the request is received from a first virtual station of the two or more virtual stations.

10. The access point of claim 9, wherein at least one association identifier indicated by the element is a corresponding association identifier used by a second virtual station of the two or more virtual stations to associate with a second access point.

11. The access point of claim 10, wherein,
the access point supports a first vendor specific physical layer features and the second access point supports a second vendor specific physical layer features,
at least one of the access point or the second access point does not support any vendor specific features, or
the access point supports a first vendor specific physical layer features, the second access point supports a second vendor specific physical layer features, and the non-access point device supports the first vendor specific physical layer features only.

12. The access point of claim 8, wherein the element includes a plurality of association identifiers, one of which corresponds to an already in-use association identifier used by a different virtual station of the non-access point device associated with a second access point.

13. The access point of claim 8, wherein,
the request is an initial association request when the non-access point device attempts to associate with the access point for a first time, or
the request is a follow up identifier uniqueness request when the non-access point device attempts to change from a previously assigned association identifier to the association identifier.

14. The access point of claim 8, wherein the element directly identifies the at least one association identifier, or implicitly identifies the at least one association identifier via a station identifier (STAID) associated with the non-access point device.

15. One or more non-transitory computer-readable media comprising computer-readable instructions, which when executed by a first access point, cause the first access point to:
receive, from a non-access point device, a request, wherein the request includes an element to signal to the first access point to exclude each of at least one association identifier indicated by the element when assigning an association identifier to the non-access point device;
assign the association identifier to the non-access point device, wherein the association identifier is different from the at least one association identifier included in the element; and
complete an association process with the non-access point device using the association identifier.

16. The one or more non-transitory computer-readable media of claim 15, wherein,
the non-access point device includes two or more virtual stations, and
the request is received from a first virtual station of the two or more virtual stations.

17. The one or more non-transitory computer-readable media of claim 16, wherein at least one association identifier indicated by the element is a corresponding association identifier used by a second virtual station of the two or more virtual stations to associate with a second access point.

18. The one or more non-transitory computer-readable media of claim 17, wherein,
the first access point supports a first vendor specific physical layer features and the second access point supports a second vendor specific physical layer features,
at least one of the first access point or the second access point does not support any vendor specific features, or
the first access point supports a first vendor specific physical layer features, the second access point supports a second vendor specific physical layer features, and the non-access point device supports the first vendor specific physical layer features only.

19. The one or more non-transitory computer-readable media of claim 15, wherein the element includes a plurality of association identifiers, one of which corresponds to an already in-use association identifier used by a different virtual station of the non-access point device associated with a second access point.

20. The one or more non-transitory computer-readable media of claim 15, wherein,
the request is an initial association request when the non-access point device attempts to associate with the first access point for a first time, or
the request is a follow up identifier uniqueness request when the non-access point device attempts to change from a previously assigned association identifier to the association identifier.
